(19) United States
(12) Patent Application Publication
(10) Pub. No.: US 2023/0212352 A1
(43) Pub. Date: Jul. 6, 2023

(54) PROCESS FOR PRODUCING POLYOXYMETHYLENE-POLYOXYALKYLENE COPOLYMERS

(71) Applicant: Covestro Deutschland AG, Leverkusen (DE)

(72) Inventors: Aurel Wolf, Wülfrath (DE); Mike Schuetze, Leverkusen (DE); Christoph Guertler, Köln (DE)

(21) Appl. No.: 17/926,305

(22) PCT Filed: Jun. 7, 2021
(86) PCT No.: PCT/EP2021/065107

§ 371 Date: Nov. 18, 2022

(30) Foreign Application Priority Data
Jun. 12, 2020 (EP) 20179673.7

(51) Int. Cl. C08G 65/26; C08G 18/56

(52) U.S. Cl. CPC C08G 65/2663; C08G 18/56

(57) ABSTRACT

A process for producing a polyoxymethylene-polyoxyalkylene copolymer is provided. The process comprises reacting a polymer formaldehyde compound of an alkylene oxide and a specific component (X) in the presence of a double metal cyanide (DMC) catalyst. A polyoxymethylene-polyoxyalkylene copolymer can be obtained by means of such a process and to the use of same for producing a polyurethane polymer.

### CROSS REFERENCE TO RELATED APPLICATIONS

This application is a U.S. national stage application, filed under 35 U.S.C. § 371, of International Application No. PCT/EP2021/065107, which was filed on Jun. 7, 2021, which claims priority to European Patent Application No. 20179673.7, which was filed on Jun. 12, 2020. The contents of each are hereby incorporated by reference into this specification.

### FIELD

The present invention describes a process for preparing a polyoxymethylene-polyoxyalkylene copolymer comprising reaction of a polymeric formaldehyde compound of an alkylene oxide and a specific component (X) in the presence of a double metal cyanide (DMC) catalyst; It further relates to a polyoxymethylene-polyoxyalkylene copolymer obtainable by such a process and to the use thereof for preparing a polyurethane polymer.

### BACKGROUND

WO2015/155094 A1 discloses a process for preparing polyoxymethylene block copolymers comprising the step of activating the DMC catalyst in the presence of an OH-terminated polymeric formaldehyde compound with a defined amount of alkylene oxide and an optional subsequent polymerization with alkylene oxides which is optionally carried out in the presence of further comonomers. In a first step the DMC catalyst is activated in the presence of the polymeric formaldehyde starter compound, wherein activation of the DMC catalyst is accomplished by adding a subamount (based on the total amount of the amount of alkylene oxides employed in the activation and polymerization) of one or more alkylene oxides, and in a second step one or more alkylene oxides and optionally carbon dioxide are added to the mixture resulting from step (i). The activation of the DMC catalyst in the first step (i) is carried out at an activation temperature (T_{act}) of 20° C. to 120° C. The functionality of the resulting polyoxymethylene block copolymers is limited to the functionality of the employed polymeric formaldehyde starter compound of two.

PCT/EP2019/081407 discloses a process for preparing polyoxymethylene-polyalkylene oxide block copolymers comprising the step of polymerizing an alkylene oxide in the presence of an OH-terminated polyoxymethylene polymer as a polymeric formaldehyde starter compound and a catalyst, wherein the polyoxymethylene polymer has a number-average molecular weight Mn of ≥1100 g/mol to ≤2300 g/mol. The functionality of the resulting polyoxymethylene block copolymers is therein likewise limited to the functionality of the employed relatively long-chain OH-terminated polyoxymethylene starter compound of two. Furthermore, the polyoxymethylene-polyalkylene oxide block copolymers have molar masses of more than 6700 g/mol which have only limited suitability for numerous applications of these difunctional hydroxyl-terminated copolymers with polyisocyanates to afford polyurethanes, especially rigid polyurethane foams.

WO 2020/083814 A1 discloses a process for preparing a polyoxymethylene-polyoxyalkylene block copolymer comprising reacting a polymeric formaldehyde compound with alkylene oxides in the presence of a double metal cyanide (DMC) catalyst and an H-functional starter substance, wherein the theoretical molar mass of the polymeric formaldehyde compound is less than the theoretical molar mass of the H-functional starter substance. It is a characteristic of DMC catalysts that they exhibit specific “catch-up” kinetics (M. Ionescu; Chemistry and Technology of Polyols for Polyurethanes 2nd Edition, Rapra Techn. Ltd., 2016 section 5.1), wherein for mixtures of H-functional starter substances of low equivalent weight and high equivalent weight the alkoxylation, especially the propoxylation, preferably takes place at the H-functional starter substance of low equivalent weight. As a result, this so-called product to product process primarily alkoxylates the polymeric formaldehyde compound instead of the likewise difunctional polyoxymethylene-polyoxyalkylene block copolymer which is used as the H-functional starter substance.

### SUMMARY

Starting from the prior art, it is accordingly an object of the present invention to provide a simple and economically advantageous single-step process for preparing polyoxymethylene-polyoxyalkylene copolymers by reacting oligomeric and polymeric forms of formaldehyde as the starter substance with alkylene oxides, which overcomes the problems resulting from the prior art. The aim here is to provide single-phase polyoxymethylene-polyoxyalkylene copolymers, wherein the proportion of oxymethylene units deriving from the polymeric formaldehyde compound in the copolymer is increased while the proportion of oxyalkylene units deriving from the alkylene oxide is simultaneously reduced. The molar masses and the product properties of the copolymers, for example the viscosity and the polydispersity index of the polyoxymethylene-polyoxyalkylene copolymers, should be comparable with commercially available polyols, so that direct further processing of these copolymers at least as a constituent of the polyol component to afford polyurethanes by reaction with polyisocyanates, especially to afford polyurethane foams, is possible

It is moreover a partial object of the present invention to vary the functionality, especially the hydroxyl functionality, i.e. the number of free hydroxyl groups, of the resulting polyoxymethylene-polyoxyalkylene copolymers relative to the functionality of the employed polymeric formaldehyde compound, which is approximately two, in ideally a single-step process in order to allow additional possible applications of this product—especially for polyurethanes with a particular focus on polyurethane foams. In particular the functionality, i.e. the number of terminal hydroxyl groups of the copolymer, shall be greater than 2.0, preferably from 2.4 to 6 and particularly preferably from 2.6 to 5.8, to allow spatial crosslinking of the copolymer as a polyol component in the preparation of polyurethanes, especially polyurethane foams According to the invention this varying of the functionality of the resulting copolymer should be effected directly during preparation of the copolymer. This single-step process has, inter alia, an apparatus-related advantage compared to the typically two-step blending process known from the prior art, i.e. mixing of at least two polyols of different functionality and/or number-average molar mass to prepare a polyol mixture having an average functionality and/or average number-average molar mass, since the polyols which are in some cases only moderately miscible in the blending process sometimes require costly and inconvenient mixing in an additional process step to obtain a polyol mixture (“blend”) having an average functionality. The molar amount of alkylene oxide used to prepare the single-phase, homogeneous copolymer using the process according to the invention should be at most comparable and not elevated compared to the total molar amount of alkylene oxide (cumulative alkylene oxide molar amount of the at least two polyols) for preparing the polyol mixture known from the prior art.

The number-average molecular weight Mn of the resulting copolymer shall also preferably have values in the range from 500 g/mol to 5000 g/mol to realize direct further processing for polyurethane applications, especially rigid polyurethane foams and flexible polyurethane foams.

According to the invention this object is achieved by a process for preparing a polyoxymethylene-polyoxyalkylene copolymer comprising reaction of a polymeric formaldehyde compound of an alkylene oxide and a component (X) in the presence of a double metal cyanide (DMC) catalyst;
wherein the polymeric formaldehyde compound has at least one terminal hydroxyl group;
wherein component (X) comprises at least one terminal hydroxyl group, at least one terminal carboxyl group and/or at least one terminal thiol group, preferably at least one terminal hydroxyl group;
wherein the theoretical molar mass of the polymeric formaldehyde compound is greater than the theoretical molar mass of component (X);
   wherein component (X) is distinct from compounds of formula (I),

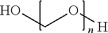

and wherein n in formula (I) is a natural number from 0 to 100.

### DETAILED DESCRIPTION

The use of the word “a” in connection with countable parameters should be understood here and hereinafter to mean the number one only when this is evident from the context (for example through the wording “precisely one”). Otherwise, expressions such as “an alkylene oxide”, “a polymeric formaldehyde compound” etc. always also encompass embodiments in which two or more alkylene oxides, two or more polymeric formaldehyde compounds etc. are used.

The invention is illustrated in detail hereinafter. Various embodiments may be combined with one another as desired unless the opposite is clearly apparent to a person skilled in the art from the context.

In the context of the present invention polyoxymethylene copolymers are to be understood as meaning polymeric compounds containing polyoxymethylene units and polyoxyalkylene and/or polyoxyalkylene carbonate units, preferably polyoxyalkylene units.

In one embodiment of the process according to the invention, the polyoxymethylene-polyoxyalkylene copolymer has a number-average molecular weight of 1000 g/mol to 10 000 g/mol, preferably of 1000 g/mol to 5000 g/mol, particularly preferably of 1000 g/mol to 3000 g/mol, wherein the number-average molecular weight is determined by gel permeation chromatography (GPC) on the basis of DIN 55672-1: “Gel permeation chromatography—Part 1: Tetrahydrofuran as elution solvent”, wherein polystyrene samples of known molar mass were used for calibration.

The obtained polyoxymethylene copolymers offer a number of advantages over existing polymers. Thus, particular physical properties such as glass transition temperatures, melting ranges, viscosities and solubilities etc. may be specifically controlled via the length of the polyoxymethylene blocks relative to the oligomeric polyoxyalkylene blocks.

Compared to polyoxymethylene homopolymers of the same molecular weight, partial crystallinity in the polyoxymethylene-polyoxyalkylene copolymers of the invention is typically lowered, which typically likewise leads to a lowering of glass transition temperatures, melting points and viscosities, etc. The presence of additional polyoxyalkylene blocks additionally leads typically to a distinct increase in the chemical and thermal stability. In addition, the polyoxymethylene-polyoxyalkylene copolymers obtained generally have good solubilities in various solvents, are usually meltable readily and without loss of mass, or are already in the liquid state at low temperatures. Compared to polyoxymethylene homopolymers, the polyoxymethylene-polyoxyalkylene copolymers thus show significantly better processability.

Compared to polyether polyols of the same molecular weight, the proportion of polyoxyalkylene units which are prepared from the corresponding alkylene oxides is reduced by the polyoxymethylene content, which contributes to an advantageous economic viability of the product. Various physical properties such as glass transition temperatures, melting ranges, viscosities, solubility, etc. can be specifically controlled for a given molecular weight via the proportion of polyoxymethylene relative to the polyoxyalkylene blocks and via the molecular weight of the employed polymeric formaldehyde compound.

This may result in advantageous physical properties, particularly of conversion products of these polymers, and hence enable new applications.

The term “alkyl” in the context of the overall invention generally includes substituents from the group of n-alkyl such as ethyl or propyl but not methyl, branched alkyl and/or cycloalkyl. The term “aryl” in the context of the overall invention generally includes substituents from the group of carbo- or heteroaryl substituents such as phenyl and/or polycyclic carbo- or heteroaryl substituents which may optionally be substituted by further alkyl groups and/or heteroatoms such as nitrogen, oxygen, silicon, sulfur or phosphorus. The radicals R1, R2, R3 and/or R4 may be joined to one another within a repeating unit such that they form cyclic structures, for example a cycloalkyl radical incorporated into the polymer chain via two adjacent carbon atoms.

Suitable polymeric formaldehyde compounds for the process of the invention are in principle those oligomeric and polymeric forms of formaldehyde having at least one terminal hydroxyl group for reaction with the alkylene oxides and any further comonomers. According to the invention, the term “terminal hydroxyl group” is to be understood as meaning in particular a terminal hemiacetal functionality which is formed as a structural feature by the polymerization of formaldehyde. The starter compounds may for example be oligomers and polymers of formaldehyde of general formula (II)

HO—(CH₂O)ₙ—H (II)

wherein n is an integer≥2 and wherein polymeric formaldehyde typically has n>8 repeating units.

Polymeric formaldehyde compounds suitable for the process according to the invention generally have molecular weights from 62 to 30 000 g/mol, preferably from 62 to 12 000 g/mol, particularly preferably from 242 to 6000 g/mol and very particularly preferably from 242 to 3000 g/mol and comprise from 2 to 1000, preferably from 2 to 400, particularly preferably from 8 to 200 and very particularly preferably from 8 to 100 oxymethylene repeating units n. The compounds used in the process according to the invention typically have a functionality (F) of 1 to 3 but in certain cases can also be polyfunctional, i.e. have a functionality>3. The process according to the invention preferably employs open-chain polymeric formaldehyde compounds having terminal hydroxyl groups and having a functionality of 1 to 10, preferably of 1 to 5, particularly preferably of 2 to 3. It is very particularly preferable when the process according to the invention employs linear polymeric formaldehyde compounds having a functionality of 2. The functionality F corresponds to the number of OH end groups per molecule.

Preparation of the polymeric formaldehyde compounds used for the process according to the invention may be carried out by known processes (cf., for example, M. Haubs et al., 2012, Polyoxymethylenes, Ullmann's Encyclopedia of Industrial Chemistry; G. Reus et al., 2012, Formaldehyde, ibid.). In principle, the formaldehyde compounds can also be used in the form of a copolymer in the process according to the invention. Further suitable formaldehyde copolymers for the process according to the invention are copolymers of formaldehyde and of trioxane with cyclic and/or linear formals, for example butanediol formal. It is likewise conceivable for higher homologous aldehydes, for example acetaldehyde, propionaldehyde, etc., to be incorporated into the formaldehyde polymer as comonomers. It is likewise conceivable for formaldehyde compounds according to the invention in turn to be prepared from H-functional starter compounds; obtainable here in particular through the use of polyfunctional compounds are polymeric formaldehyde compounds having a hydroxyl end group functionality F>2 (cf., for example, WO 1981001712 A1, Bull. Chem. Soc. J., 1994, 67, 2560-2566, U.S. Pat. No. 3,436,375, JP 03263454, JP 2928823).

As is well known, formaldehyde requires only the presence of small traces of water to polymerize. In aqueous solution a mixture of oligomers and polymers of different chain lengths which are in equilibrium with molecular formaldehyde and formaldehyde hydrate is thus formed according to the concentration and the temperature of the solution. So-called paraformaldehyde precipitates out of the solution here as a white, sparingly soluble solid, and is generally a mixture of linear formaldehyde polymers where n=8 to 100 repeat oxymethylene units.

One particular advantage of the process of the invention is that polymeric formaldehyde or so-called paraformaldehyde, which is commercially available and inexpensive, may be used directly as a reactant without the need for additional preparatory steps. In an advantageous embodiment of the invention, paraformaldehyde is therefore employed as the reactant.

Preferably employed here are linear formaldehyde compounds of general formula (II) HO—(CH₂O)n-H, wherein n is an integer≥2, preferably where n=2 to 1000, particularly preferably where n=2 to 400 and very particularly preferably where n=8 to 100, having two terminal hydroxyl groups. Especially also employable as starter compound are mixtures of polymeric formaldehyde compounds of formula HO—(CH₂O)n-H having different values of n in each case. In an advantageous embodiment, the employed mixtures of polymeric formaldehyde starter compounds of formula (II) HO—(CH₂O)n-H contain at least 1% by weight, preferably at least 5% by weight and particularly preferably at least 10% by weight of polymeric formaldehyde compounds where n≥20.

In a preferred embodiment of the process according to the invention, the polymeric formaldehyde compound has 2 hydroxyl groups and 8 to 100 oxymethylene repeating units (n) or 3 hydroxyl groups and 8 to 100 oxymethylene repeating units (n).

According to the invention the theoretical molar mass of the polymeric formaldehyde compound is greater than the theoretical molar mass of component (X)

Furthermore, component (X) is distinct from compounds of formula (I),

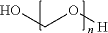

wherein n in formula (I) is a natural number from 0 to 100.

Compounds of formula (I) comprise for example water where n=0 or monomeric, oligomeric or polymeric formaldehyde compounds where n=1 to 100.

Component (X) according to the invention further comprises at least one terminal hydroxyl group, at least one terminal carboxyl group and/or at least one terminal thiol group, preferably at least one terminal hydroxyl group.

In one embodiment of the process according to the invention, component (X) comprises one to six terminal hydroxyl groups, one to six terminal carboxyl groups and/or one to six terminal thiol groups, preferably two to six terminal hydroxyl groups, two to six terminal carboxyl groups and/or two to six terminal thiol groups, particularly preferably three to six terminal hydroxyl groups, three to six terminal carboxyl groups and/or three to six terminal thiol groups.

In a most preferred embodiment of the process according to the invention, component (X) comprises three to six terminal hydroxyl groups such as for example 1,1,1-trimethylolpropane, glycerol, pentaerythritol, sorbitol, sucrose, xylitol.

In one embodiment of the process according to the invention, the number of terminal hydroxyl groups, terminal carboxyl groups and/or terminal thiol groups of component (X) is distinct from the number of terminal hydroxyl groups of the polymeric formaldehyde compound. This allows the functionality of the resulting polyoxymethylene-polyoxyalkylene copolymer to be specifically adjusted. Especially three to six terminal hydroxyl groups, three to six terminal carboxyl groups and/or three to six terminal thiol groups of component (X) make it possible to establish for the resulting polyoxymethylene-polyoxyalkylene copolymer a functionality, i.e. the number of terminal hydroxyl groups, of greater than 2.0, preferably of 2.4 to 6 and particularly preferably of 2.6 to 5.8 which is essential for subsequent applications of this polyoxymethylene-polyoxyalkylene copolymer such as for example in the preparation of polyurethanes (PU), for example rigid polyurethane foams or flexible polyurethane foams, by reaction of the polyoxymethylene-polyoxyalkylene copolymer with a polyisocyanate to be able to provide spatially crosslinked polyurethanes, especially PU foams.

In one embodiment of the process according to the invention, component (X) is an OH-functional starter substance (1-1), an SH-functional starter substance (1-2) and/or a COOH-functional starter substance (1-3), preferably an OH-functional starter substance (1-1).

An OH-functional starter substance (1-1) is to be understood as meaning a compound having at least one free (terminal) hydroxyl group, an SH-functional starter substance (1-2) having at least one thiol group and/or a COOH-functional starter substance (1-3) having at least one free carboxyl group.

Component (X) may for example be one or more compounds selected from the group comprising water or monohydric or polyhydric alcohols, monobasic or polybasic carboxylic acids, hydroxycarboxylic acids, hydroxy esters, polyether polyols, polyester polyols, polyesterether polyols, polyethercarbonate polyols, polyetherestercarbonate polyols, polycarbonate polyols, polycarbonates, polytetrahydrofurans (e.g. PolyTHF® from BASF, such as PolyTHF® 250, 650S, 1000, 1000S, 1400, 1800, 2000), polyacrylate polyols, castor oil, the mono- or diglyceride of ricinoleic acid, monoglycerides of fatty acids, chemically modified mono-, di- and/or triglycerides of fatty acids, and C1-C24 alkyl fatty acid esters containing an average of at least 2 OH groups per molecule. Examples of C1-C23 alkyl fatty acid esters containing an average of at least 2 OH groups per molecule are commercial products such as Lupranol Balance® (from BASF AG), Merginol® products (from Hobum Oleochemicals GmbH), Sovermol® products (from Cognis Deutschland GmbH & Co. KG), and Soyol®™ products (from USSC Co.).

Component (X) may be selected from monofunctional starter substances such as alcohols as an OH-functional starter substance (1-1), thiols as an SH-functional starter substance (1-2) and carboxylic acids as a COOH-functional starter substance (1-3). Monofunctional alcohols that may be used include: methanol, ethanol, ethenol, 1-propanol, 2-propanol, 2-propenol, 1-butanol, 2-butanol, tert-butanol, 3-buten-1-ol, 3-butyn-1-ol, 2-methyl-3-buten-2-ol, 2-methyl-3-butyn-2-ol, propargyl alcohol, 2-methyl-2-propanol, 1-tert-butoxy-2-propanol, 1-pentanol, 2-pentanol, 3-pentanol, 1-hexanol, 2-hexanol, 3-hexanol, 1-heptanol, 2-heptanol, 3-heptanol, 1-octanol, 2-octanol, 3-octanol, 4-octanol, 1-dodecanol, Palmerol, 1-hexadecanol, phenol, 2-hydroxybiphenyl, 3-hydroxybiphenyl, 4-hydroxybiphenyl.

Suitable polyhydric alcohols as OH-functional starter substances (1-1) having at least two terminal hydroxyl groups are, for example, dihydric alcohols (for example ethylene glycol, diethylene glycol, propylene glycol, dipropylene glycol, propane-1,3-diol, butane-1,4-diol, butene-1,4-diol, butyne-1,4-diol, neopentyl glycol, pentantane-1,5-diol, methylpentanediols (for example 3-methylpentane-1,5-diol), hexane-1,6-diol, octane-1,8-diol, decane-1,10-diol, dodecane-1,12-diol, bis(2-hydroxyethyl) terephthalate, bis(hydroxymethyl)cyclohexanes (for example 1,4-bis(hydroxymethyl)cyclohexane), triethylene glycol, tetraethylene glycol, polyethylene glycols, dipropylene glycol, tripropylene glycol, polypropylene glycols, dibutylene glycol, and polybutylene glycols); trihydric alcohols (for example trimethylolpropane, glycerol, trishydroxyethyl isocyanurate, castor oil); tetrahydric alcohols (for example pentaerythritol); polyalcohols (for example sorbitol, hexitol, sucrose, starch, starch hydrolyzates, cellulose, cellulose hydrolyzates, hydroxy-functionalized fats and oils, especially castor oil), and also all products of modification of these aforementioned alcohols having different amounts of ε-caprolactone.

SH-functional starter substances (1-2) include for example acetylcysteine, dimercaptosuccinic acid, dimercaptopropanesulfonic acid, ethanethiol (ethylmercaptan), dithiothreitol (DTT), dithioerythritol (DTE), cysteine, penicillamine, 1-propanethiol, 2-propanethiol, glutathione, homocysteine, sodium 2-mercaptoethane sulfonate, methanethiol (methyl mercaptan) and thiophenol.

Suitable monobasic carboxylic acids as COOH-functional starter substance (1-3) having a free carboxyl group are methanoic acid, ethanoic acid, propanoic acid, butanoic acid, pentanoic acid, hexanoic acid, heptanoic acid, octanoic acid, lactic acid, stearic acid, palmitic acid, oleic acid, linoleic acid, linolenic acid, benzoic acid, acrylic acid, fluoroacetic acid, chloroacetic acid, bromoacetic acid, iodoacetic acid, difluoroacetic acid, trifluoroacetic acid, dichloroacetic acid, trichloroacetic acid, oleic acid, salicylic acid and benzoic acid. It is also possible to employ mixtures of fatty acid/fatty alcohol, preferably C10-C18.

According to the invention polybasic carboxylic acids as a COOH-functional starter substance (1-3) having at least two carboxyl groups include one or more compounds selected from the group consisting of oxalic acid, malonic acid, succinic acid, glutaric acid, adipic acid, pimelic acid, suberic acid, azelaic acid, sebacic acid, trimesic acid, fumaric acid, maleic acid, decane-1,10-dicarboxylic acid, dodecane-1,12-dicarboxylic acid, phthalic acid, isophthalic acid, terephthalic acid, pyromellitic acid and trimellitic acid.

Component (X) may also be selected from suitable hydroxycarboxylic acids including, for example, ricinoleic acid, glycolic acid, lactic acid, 3-hydroxypropionic acid, malic acid, citric acid, mandelic acid, tartronic acid, tartaric acid, mevalonic acid, 4-hydroxybutyric acid, salicylic acid, 4-hydroxybenzoic acid and isocitric acid.

The OH-functional starter substances (1-1) may also be selected from the class of the polyether polyols, in particular those having a molecular weight Mn in the range from 50 to 4000 g/mol, preferably from 50 to 2000 g/mol and particularly preferably from 50 to 1000 g/mol. Preference is given to polyether polyols formed from repeat ethylene oxide and propylene oxide units, preferably having a proportion of 35% to 100% of propylene oxide units, particularly preferably having a proportion of 50% to 100% of propylene oxide units. These may be random copolymers, gradient copolymers, alternating copolymers or block copolymers of ethylene oxide and propylene oxide. Suitable polyether polyols formed from repeat propylene oxide and/or ethylene oxide units are, for example, the Desmophen®, Acclaim®, Arcol®, Baycoll®, Bayfill®, Bayflex®, Baygal®, PET® and polyether polyols from Covestro AG (e.g. Desmophen® 3600Z, Desmophen® 1900U, Acclaim® Polyol 2200, Acclaim® Polyol 40001, Arcol® Polyol 1004, Arcol® Polyol 1010, Arcol® Polyol 1030, Arcol® Polyol 1070, Baycoll® BD 1110, Bayfill® VPPU 0789, Baygal® K55, PETR 1004, PolyetherR S180). Further suitable homopolyethylene oxides are for example the Pluriol@ E products from BASF SE, suitable homopolypropylene oxides are for example the Pluriol@ P products from BASF SE, suitable mixed copolymers of ethylene oxide and propylene oxide are for example the Pluronic® PE or Pluriol® RPE products from BASF SE.

The OH-functional starter substances (1-1) may also be selected from the class of the polyester polyols, in particular those having a molecular weight Mn in the range from 50 to 4000 g/mol, preferably from 50 to 2000 g/mol and particularly preferably from 100 to 1000 g/mol. Polyester polyols employed may be selected from at least difunctional polyesters. Polyester polyols preferably consist of alternating acid and alcohol units. Examples of acid components that may be used include succinic anhydride, maleic acid, maleic anhydride, adipic acid, phthalic anhydride, phthalic acid, isophthalic acid, terephthalic acid, tetrahydrophthalic acid, tetrahydrophthalic anhydride, hexahydrophthalic anhydride, or mixtures of the recited acids and/or anhydrides. Alcohol components employed include for example ethanediol, propane-1,2-diol, propane-1,3-diol, butane-1,4-diol, pentane-1,5-diol, neopentyl glycol, hexane-1,6-diol, 1,4-bis(hydroxymethyl)cyclohexane, diethylene glycol, dipropylene glycol, trimethylolpropane, glycerol, pentaerythritol, or mixtures of the stated alcohols. The resulting polyester polyols have terminal hydroxyl and/or carboxyl groups.

OH-functional starter substances (1-1) that may be employed further include polycarbonate diols, in particular those having a molecular weight Mn in the range from 50 to 4000 g/mol, preferably from 50 to 2000 g/mol and particularly preferably from 50 to 1000 g/mol which are prepared for example by reaction of phosgene, dimethyl carbonate, diethyl carbonate or diphenyl carbonate and difunctional alcohols or polyester polyols or polyether polyols. Examples of polycarbonates may be found, for example, in EP-A 1359177. Polycarbonate diols that may be used include for example the Desmophen® C line from Covestro AG, for example DesmophenR C 1100 or Desmophen® C 2200.

A further embodiment of the invention may employ polyether carbonate polyols (for example Cardyon® polyols from Covestro), polycarbonate polyols (for example Converge® polyols from Novomer/Saudi Aramco, NEOSPOL polyols from Repsol etc.) and/or polyether ester carbonate polyols as OH-functional starter compounds (1-1). Polyethercarbonate polyols, polycarbonate polyols and/or polyetherestercarbonate polyols may in particular be obtained by reaction of alkylene oxides, preferably ethylene oxide, propylene oxide or mixtures thereof, optionally further comonomers, with CO₂ in the presence of a further H-functional starter compound and using catalysts. These catalysts include double metal cyanide catalysts (DMC catalysts) and/or metal complex catalysts for example based on the metals zinc and/or cobalt, for example zinc glutarate catalysts (described for example in M. H. Chisholm et al., Macromolecules 2002, 35, 6494), so-called zinc diiminate catalysts (described for example in S. D. Allen, J. Am. Chem. Soc. 2002, 124, 14284) and so-called cobalt-salen catalysts (described, for example, in U.S. Pat. No. 7,304,172 B2, US 2012/0165549 A1) and/or manganese-salen complexes. An overview of the known catalysts for the copolymerization of alkylene oxides and CO₂ is given for example by Chemical Communications 47 (2011) 141-163. The use of different catalyst systems, reaction conditions and/or reaction sequences results in the formation of random, alternating, block-type or gradient-type polyether carbonate polyols, polycarbonate polyols and/or polyether ester carbonate polyols. To this end, these polyether carbonate polyols, polycarbonate polyols and/or polyether ester carbonate polyols used as OH-functional starter compounds (1-1) may be prepared beforehand in a separate reaction step.

The OH-functional starter substances (1-1) generally have an OH functionality (i.e. the number of polymerization-active H atoms per molecule) of 1 to 8, preferably of 2 to 6 and more preferably of 2 to 4. The OH-functional starter substances (1-1) are used either individually or as a mixture of at least two OH-functional starter substances (1-1).

Preferred OH-functional starter substances (1-1) are alcohols having a composition according to general formula (III)

HO—(CH2)_{X}—OH (III)
wherein x is a number from 1 to 20, preferably an even number from 2 to 20. Examples of alcohols of formula (1) are ethylene glycol, propane-1,3-diol, butane-1,4-diol, hexane-1,6-diol, octane-1,8-diol, decane-1,10-diol and dodecane-1,12-diol. Further preferred OH-functional starter substances (1-1) are neopentyl glycol, trimethylolpropane, glycerol and pentaerythritol.

Also preferably employed as OH-functional starter substances (1-1) are diethylene glycol, dipropylene glycol, castor oil, sorbitol and polyether polyols formed from repeat polyalkylene oxide units.

The OH-functional starter substance (1-1) is particularly preferably one or more compounds selected from the group consisting of ethylene glycol, propylene glycol, propane-1,3-diol, butane-1,3-diol, butane-1,4-diol, pentane-1,5-diol, 2-methylpropane-1,3-diol, neopentyl glycol, hexane-1,6-diol, diethylene glycol, dipropylene glycol, glycerol, trimethylolpropane, di- and trifunctional polyether polyols, where the polyether polyol is formed from a di- or tri-H-functional starter substance and propylene oxide or a di- or tri-H-functional starter substance, propylene oxide and ethylene oxide. The polyether polyols preferably have an OH functionality of 2 to 4 and a molecular weight Mn in the range from 62 to 4500 g/mol and in particular a molecular weight Mn in the range from 62 to 3000 g/mol.

In one embodiment of the process according to the invention, the OH-functional starter substance (1-1) as component (X) has an OH-functionality of 3 to 6 and a molecular weight Mn of 50 g/mol to 2000 g/mol, preferably an OH-functionality 2 to 4 and a molecular weight Mn of 50 g/mol to 1000 g/mol.

In one embodiment of the process according to the invention, component (X) is one or more compound(s) and is selected from the group consisting of ethylene glycol, diethylene glycol, polyethylene glycol, propylene glycol, methylpropylene glycol, dipropylene glycol, polypropylene glycol, butane-1,3-diol, butane-1,4-diol, 1,1,1-trimethylolpropane, glycerol, pentaerythritol, sorbitol, sucrose, xylitol, propane-1,2-diol, propane-1,3-diol, bisphenol A, 1,2,3-trihydroxybenzene, 1,2,4-trihydroxybenzene, 1,3,5-trihydroxybenzene, 1,2,4,5-tetrahydroxybenzene, trihydroxytoluenes (all isomers), benzenehexol, hydroxyquinone, succinic acid, adipic acid, glutaric acid, pimelic acid, maleic acid, phthalic acid, terephthalic acid, lactic acid, citric acid, salicylic acid and esters of the aforementioned alcohols and acids.

In a preferred embodiment of the process according to the invention, component (X) is one or more compound(s) and is selected from the group consisting of ethylene glycol, diethylene glycol, polyethylene glycol, methylpropylene glycol, dipropylene glycol, polypropylene glycol, butane-1,3-diol, butane-1,4-diol, 1,1,1-trimethylolpropane, glycerol, pentaerythritol, sorbitol, sucrose, xylitol, propane-1,2-diol, propane-1,3-diol, preferably polypropylene glycol, 1,1,1-trimethylolpropane, glycerol and sorbitol.

In one embodiment of the process according to the invention, the mole fraction of component (X) is from 0.5 mol % to 95 mol %, preferably from 1 mol % to 90 mol % and particularly preferably from 10 mol % to 85 mol % based on the sum of the molar amounts of the polymeric formaldehyde compound and component (X).

In a preferred embodiment of the process according to the invention, component (X) comprises three to six terminal hydroxyl groups and component (X) comprises from 0.5 mol % to 95 mol %, preferably from 1 mol % to 90 mol % and particularly preferably from 10 mol % to 85 mol % based on the sum of the molar amounts of the polymeric formaldehyde compound.

Epoxide alkylene oxides (epoxides) used for preparing the polyoxymethylene copolymers are compounds of general formula (IV):

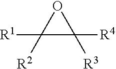

wherein R¹, R², R³ and R⁴ are independently hydrogen or an alkyl or aryl radical which may optionally contain additional heteroatoms such as nitrogen, oxygen, silicon, sulfur or phosphorus and may optionally be joined to one another so as to form cyclic structures, for example a cycloalkylene oxide.

In the context of the process according to the invention it is possible in principle to use any alkylene oxides suitable for polymerization in the presence of a DMC catalyst. If different alkylene oxides are used these may be metered in either as a mixture or consecutively. In the case of the latter metered addition the polyether chains of the polyoxymethylene-polyoxyalkylene copolymer obtained in this way may in turn likewise have a copolymer structure.

The process according to the invention may generally employ alkylene oxides (epoxides) having 2-24 carbon atoms. The alkylene oxides having 2-24 carbon atoms are, for example, one or more compounds selected from the group consisting of ethylene oxide, propylene oxide, 1-butene oxide, 2,3-butene oxide, 2-methyl-1,2-propene oxide (isobutene oxide), 1-pentene oxide, 2,3-pentene oxide, 2-methyl-1,2-butene oxide, 3-methyl-1,2-butene oxide, 1-hexene oxide, 2,3-hexene oxide, 3,4-hexene oxide, 2-methyl-1,2-pentene oxide, 4-methyl-1,2-pentene oxide, 2-ethyl-1,2-butene oxide, 1-heptene oxide, 1-octene oxide, 1-nonene oxide, 1-decene oxide, 1-undecene oxide, 1-dodecene oxide, 4-methyl-1,2-pentene oxide, butadiene monoxide, isoprene monoxide, cyclopentene oxide, cyclohexene oxide, cycloheptene oxide, cyclooctene oxide, styrene oxide, methylstyrene oxide, pinene oxide, mono- or polyepoxidized fats as mono-, di- and triglycerides, epoxidized fatty acids, C1-C24 esters of epoxidized fatty acids, epichlorohydrin, glycidol, and derivatives of glycidol, for example methyl glycidyl ether, ethyl glycidyl ether, 2-ethylhexyl glycidyl ether, allyl glycidyl ether, glycidyl methacrylate and epoxy-functional alkyloxysilanes, for example 3-glycidyloxypropyltrimethoxysilane, 3-glycidyloxypropyltriethoxysilane, 3-glycidyloxypropyltripropoxysilane, 3-glycidyloxypropylmethyldimethoxysilane, 3-glycidyloxypropylethyldiethoxysilane, 3-glycidyloxypropyltriisopropoxysilane. The epoxide of general formula (I) is preferably a terminal epoxide wherein R1, R2 and R3 are hydrogen and R4 may be hydrogen, an alkyl or aryl radical optionally containing additional heteroatoms such as nitrogen, oxygen, silicon, sulfur or phosphorus and may differ in different repeating units.

In a preferred embodiment of the process according to the invention, the alkylene oxide is one or more compound(s) and is selected from the group consisting of ethylene oxide, propylene oxide, styrene oxide and cyclohexene oxide, preferably ethylene oxide and propylene oxide and particularly preferably propylene oxide.

### Suspension Medium

One embodiment of the process according to the invention employs a suspension medium, wherein the employed suspension medium preferably contains no H-functional groups. Suitable suspension media having no H-functional groups include all polar aprotic, weakly polar aprotic and nonpolar aprotic solvents, none of which contain any H-functional groups. A mixture of two or more of these suspension media may also be employed as the suspension medium.

In one embodiment of the process according to the invention, the suspension medium containing no H-functional groups is one or more compounds selected from the group consisting of 4-methyl-2-oxo-1,3-dioxolane, 1,3-dioxolan-2-one, acetone, methyl ethyl ketone, acetonitrile, nitromethane, dimethyl sulfoxide, sulfolane, dimethylformamide, dimethylacetamide, N-methylpyrrolidone, dioxane, diethyl ether, methyl tert-butyl ether, tetrahydrofuran, ethyl acetate, butyl acetate, pentane, n-hexane, benzene, toluene, xylene, ethylbenzene, chloroform, chlorobenzene, dichlorobenzene and carbon tetrachloride.

Preferred suspension media containing no H-functional groups include 4-methyl-2-oxo-1,3-dioxolane, 1,3-dioxolan-2-one, toluene, xylene, ethylbenzene, chlorobenzene and dichlorobenzene and also mixtures of two or more of these suspension media; particular preference is given to 4-methyl-2-oxo-1,3-dioxolane and 1,3-dioxolan-2-one and toluene or a mixture of 4-methyl-2-oxo-1,3-dioxolane and 1,3-dioxolan-2-one and/or toluene. It is likewise possible to use as the suspension medium a further starter compound, that is in liquid form under the reaction conditions, in a mixture with the polymeric formaldehyde starter compound.

In an alternative embodiment of the process according to the invention, in step (a) a suspension medium containing H-functional groups is initially charged in the reactor together with DMC catalyst. In a preferred embodiment, the suspension medium containing H-functional groups containing the DMC catalyst is a polyoxymethylene-polyoxyalkylene copolymer obtainable from a preceding production process containing an activated DMC catalyst. This saves possible separation steps compared to use of a suspension medium comprising no H-functional groups, thus resulting in a simpler and more efficient process.

The double metal cyanide compounds present in the DMC catalysts preferably employable in the process according to the invention are the reaction products of water-soluble metal salts and water-soluble metal cyanide salts.

Double metal cyanide (DMC) catalysts for use in the homopolymerization of alkylene oxides are known in principle from the prior art (see, for example, U.S. Pat. Nos. 3,404,109, 3,829,505, 3,941,849 and 5,158,922). DMC catalysts, which are described, for example, in U.S. Pat. No. 5,470,813, EP-A 700 949, EP-A 743 093, EP-A 761 708, WO 97/40086, WO 98/16310 and WO 00/47649, have a very high activity and allow preparation of polyether carbonates at very low catalyst concentrations. A typical example is that of the highly active DMC catalysts described in EP-A 700 949 which, as well as a double metal cyanide compound (e.g. zinc hexacyanocobaltate(III)) and an organic complex ligand (e.g. tert-butanol), also contain a polyether having a number-average molecular weight greater than 500 g/mol.

The DMC catalysts which can be used in accordance with the invention are preferably obtained by
(1) reacting an aqueous solution of a metal salt with the aqueous solution of a metal cyanide salt in the presence of one or more organic complex ligands, e.g. an ether or alcohol, in a first step,
(2) removing the solid from the suspension obtained from (a) by known techniques (such as centrifugation or filtration) in a second step,
(3) optionally washing the isolated solid with an aqueous solution of an organic complex ligand (for example by resuspending and subsequent reisolating by filtration or centrifugation) in a third step,
(4) and subsequently drying the solid obtained at temperatures of in general 20-120° C. and at pressures of in general 0.1 mbar to atmospheric pressure (1013 mbar), optionally after pulverizing,
wherein in the first step or immediately after the precipitation of the double metal cyanide compound (second step) one or more organic complex ligands, preferably in excess (based on the double metal cyanide compound), and optionally further complex-forming components are added.

The double metal cyanide compounds present in the DMC catalysts that can be used in accordance with the invention are the reaction products of water-soluble metal salts and water-soluble metal cyanide salts.

By way of example, an aqueous zinc chloride solution (preferably in excess relative to the metal cyanide salt) and potassium hexacyanocobaltate are mixed and then dimethoxyethane (glyme) or tert-butanol (preferably in excess, relative to zinc hexacyanocobaltate) is added to the resulting suspension.

Metal salts suitable for preparing the double metal cyanide compounds preferably have a composition according to general formula (V)

M(X)n (V),
wherein
M is selected from the metal cations Zn²⁺, Fe²⁺, Ni²⁺, Mn²⁺, Co²⁺, Sr²⁺, Sn²⁺, Pb²⁺ and Cu²⁺; M is preferably Zn²⁺, Fe²⁺, Co²⁺ or Ni²⁺,
X are one or more (i.e. different) anions, preferably an anion selected from the group of halides (i.e. fluoride, chloride, bromide, iodide), hydroxide, sulfate, carbonate, cyanate, thiocyanate, isocyanate, isothiocyanate, carboxylate, oxalate and nitrate;
n is 1 if X=sulfate, carbonate or oxalate and
n is 2 if X=halide, hydroxide, carboxylate, cyanate, thiocyanate, isocyanate, isothiocyanate or nitrate,
or suitable metal salts preferably have a composition according to general formula (VI)

Mr(X)3 (VI),
wherein
M is selected from the metal cations Fe³⁺, Al³⁺, Co³⁺ and Cr³⁺,
X comprises one or more (i.e. different) anions, preferably an anion selected from the group of halides (i.e. fluoride, chloride, bromide, iodide), hydroxide, sulfate, carbonate, cyanate, thiocyanate, isocyanate, isothiocyanate, carboxylate, oxalate and nitrate;
r is 2 if X=sulfate, carbonate or oxalate and
r is 1 if X=halide, hydroxide, carboxylate, cyanate, thiocyanate, isocyanate, isothiocyanate or nitrate,
or suitable metal salts preferably have a composition according to general formula (VII)

M(X)s (VII),
wherein
M is selected from the metal cations Mo⁴⁺, V⁴⁺ and W⁴⁺,
X comprises one or more (i.e. different) anions, preferably an anion selected from the group of halides (i.e. fluoride, chloride, bromide, iodide), hydroxide, sulfate, carbonate, cyanate, thiocyanate, isocyanate, isothiocyanate, carboxylate, oxalate and nitrate;
s is 2 if X=sulfate, carbonate or oxalate and
s is 4 if X=halide, hydroxide, carboxylate, cyanate, thiocyanate, isocyanate, isothiocyanate or nitrate,
or suitable metal salts preferably have a composition according to general formula (VIII)

M(X)t (VIII),
wherein
M is selected from the metal cations Mo⁶⁺ and W⁶⁺,
X comprises one or more (i.e. different) anions, preferably anions selected from the group of halides (i.e. fluoride, chloride, bromide, iodide), hydroxide, sulfate, carbonate, cyanate, thiocyanate, isocyanate, isothiocyanate, carboxylate, oxalate and nitrate;
t is 3 if X=sulfate, carbonate or oxalate and
t is 6 if X=halide, hydroxide, carboxylate, cyanate, thiocyanate, isocyanate, isothiocyanate or nitrate.

Examples of suitable metal salts are zinc chloride, zinc bromide, zinc iodide, zinc acetate, zinc acetylacetonate, zinc benzoate, zinc nitrate, iron(II) sulfate, iron(II) bromide, iron(II) chloride, iron(III) chloride, cobalt(II) chloride, cobalt(II) thiocyanate, nickel(II) chloride and nickel(II) nitrate. It is also possible to use mixtures of different metal salts.

Metal cyanide salts suitable for preparing the double metal cyanide compounds preferably have a composition according to the general formula (IX)

(Y)a M′(CN)b(A)c (IX),
wherein
M′ is selected from one or more metal cations from the group consisting of Fe(II), Fe(III), Co(II), Co(III), Cr(II), Cr(III), Mn(II), Mn(III), Ir(III), Ni(II), Rh(III), Ru(II), V(IV) and V(V); M′ is preferably one or more metal cations from the group consisting of Co(II), Co(III), Fe(II), Fe(III), Cr(III), Ir(III) and Ni(II),
Y is selected from one or more metal cations from the group consisting of alkali metal (i.e. Li⁺, Na⁺, K⁺, Rb⁺) and alkaline earth metal (i.e. Be²⁺, Mg²⁺, Ca²⁺, Sr²⁺, Ba²⁺),
A is selected from one or more anions from the group consisting of halides (i.e. fluoride, chloride, bromide, iodide), hydroxide, sulfate, carbonate, cyanate, thiocyanate, isocyanate, isothiocyanate, carboxylate, azide, oxalate or nitrate and
a, b and c are integers, wherein the values for a, b and c are selected so as to ensure the electroneutrality of the metal cyanide salt; a is preferably 1, 2, 3 or 4; b is preferably 4, 5 or 6; c preferably has the value 0.

Examples of suitable metal cyanide salts are sodium hexacyanocobaltate(III), potassium hexacyanocobaltate(III), potassium hexacyanoferrate(II), potassium hexacyanoferrate(III), calcium hexacyanocobaltate(III) and lithium hexacyanocobaltate(III).

Preferred double metal cyanide compounds present in the DMC catalysts employable according to the invention are compounds having compositions according to general formula (IX)

M_{X}[M′_{X},(CN)_{y}]_{z} (IX),
in which M is defined as in formula (V) to (VIII) and
M′ is defined as in formula (IX) and
x, x′, y and z are integers and are selected so as to ensure the electroneutrality of the double metal cyanide compound.

It is preferable when
x=3, x′=1, y=6 and z=2,
M=Zn(II), Fe(II), Co(II) or Ni(II) and
M′=Co(III), Fe(III), Cr(III) or Ir(III).

Examples of suitable double metal cyanide compounds a) are zinc hexacyanocobaltate(III), zinc hexacyanoiridate(III), zinc hexacyanoferrate(III) and cobalt(II) hexacyanocobaltate(III). Further examples of suitable double metal cyanide compounds can be found, for example, in U.S. Pat. No. 5,158,922 (column 8, lines 29-66). With particular preference it is possible to use zinc hexacyanocobaltate(III).

The organic complex ligands which can be added in the preparation of the DMC catalysts are disclosed in, for example, U.S. Pat. No. 5,158,922 (see, in particular, column 6, lines 9 to 65), U.S. Pat. Nos. 3,404,109, 3,829,505, 3,941,849, EP-A 700 949, EP-A 761 708, JP 4 145 123, U.S. Pat. No. 5,470,813, EP-A 743 093 and WO-A 97/40086). The organic complex ligands used are, for example, water-soluble organic compounds containing heteroatoms such as oxygen, nitrogen, phosphorus or sulfur, which can form complexes with the double metal cyanide compound. Preferred organic complex ligands are alcohols, aldehydes, ketones, ethers, esters, amides, ureas, nitriles, sulfides and mixtures thereof. Particularly preferred organic complex ligands are aliphatic ethers (such as dimethoxyethane), water-soluble aliphatic alcohols (such as ethanol, isopropanol, n-butanol, isobutanol, sec-butanol, tert-butanol, 2-methyl-3-buten-2-ol and 2-methyl-3-butyn-2-ol), compounds which include both aliphatic or cycloaliphatic ether groups and aliphatic hydroxyl groups (such as ethylene glycol mono-tert-butyl ether, diethylene glycol mono-tert-butyl ether, tripropylene glycol monomethyl ether and 3-methyl-3-oxetanemethanol, for example). Extremely preferred organic complex ligands are selected from one or more compounds of the group consisting of dimethoxyethane, tert-butanol 2-methyl-3-buten-2-ol, 2-methyl-3-butyn-2-ol, ethylene glycol mono-tert-butyl ether and 3-methyl-3-oxetanemethanol.

In the preparation of the DMC catalysts which can be used in accordance with the invention, there is optional use of one or more complex-forming components from the compound classes of the polyethers, polyesters, polycarbonates, polyalkylene glycol sorbitan esters, polyalkylene glycol glycidyl ethers, polyacrylamide, poly(acrylamide-co-acrylic acid), polyacrylic acid, poly(acrylic acid-co-maleic acid), polyacrylonitrile, polyalkylacrylates, polyalkylmethacrylates, polyvinyl methyl ether, polyvinyl ethyl ether, polyvinyl acetate, polyvinyl alcohol, poly-N-vinylpyrrolidone, poly(N-vinylpyrrolidone-co-acrylic acid), polyvinyl methyl ketone, poly(4-vinylphenol), poly(acrylic acid-co-styrene), oxazoline polymers, polyalkyleneimines, maleic acid copolymers and maleic anhydride copolymers, hydroxyethylcellulose and polyacetals, or of the glycidyl ethers, glycosides, carboxylic esters of polyhydric alcohols, bile acids or salts, esters or amides thereof, cyclodextrins, phosphorus compounds, α,β-unsaturated carboxylic esters, or ionic surface-active or interface-active compounds.

In the preparation of the DMC catalysts which can be used in accordance with the invention, preference is given to using the aqueous solutions of the metal salt (e.g. zinc chloride) in the first step in a stoichiometric excess (at least 50 mol %) relative to the metal cyanide salt. This corresponds to at least a molar ratio of metal salt to metal cyanide salt of 2.25:1.00. The metal cyanide salt (e.g. potassium hexacyanocobaltate) is reacted in the presence of the organic complex ligand (e.g. tert-butanol) to form a suspension which contains the double metal cyanide compound (e.g. zinc hexacyanocobaltate), water, excess metal salt, and the organic complex ligand.

The organic complex ligand may be present in the aqueous solution of the metal salt and/or of the metal cyanide salt or it is added directly to the suspension obtained after precipitation of the double metal cyanide compound. It has proven advantageous to mix the metal salt and metal cyanide salt aqueous solutions and the organic complex ligand by stirring vigorously. Optionally, the suspension formed in the first step is subsequently treated with a further complex-forming component. This complex-forming component is preferably used in a mixture with water and organic complex ligand. A preferred process for performing the first step (i.e. the preparation of the suspension) is effected using a mixing nozzle, more preferably using a jet disperser, as described, for example, in WO-A 01/39883.

In the second step, the solid (i.e. the precursor of the catalyst) can be isolated from the suspension by known techniques, such as centrifugation or filtration.

In a preferred variant, the isolated solid is then washed with an aqueous solution of the organic complex ligand (for example by resuspension and subsequent reisolation by filtration or centrifugation) in a third process step. In this way, for example, water-soluble by-products, such as potassium chloride, can be removed from the catalyst that can be used in accordance with the invention. The amount of the organic complex ligand in the aqueous washing solution is preferably between 40 and 80% by weight based on the total solution.

Optionally, in the third step, the aqueous wash solution is admixed with a further complex-forming component, preferably in the range between 0.5% and 5% by weight, based on the overall solution.

It is moreover advantageous to wash the isolated solid more than once. In a first washing step (3.-1), washing is preferably effected with an aqueous solution of the unsaturated alcohol (for example by resuspension and subsequent reisolation by filtration or centrifugation), in order thereby to remove, for example, water-soluble by-products, such as potassium chloride, from the catalyst usable in accordance with the invention. The amount of the unsaturated alcohol in the aqueous wash solution is more preferably between 40% and 80% by weight, based on the overall solution of the first washing step. In the further washing steps (3.-2), either the first washing step is repeated one or more times, preferably from one to three times, or, preferably, a nonaqueous solution, for example a mixture or solution of unsaturated alcohol and further complex-forming component (preferably in the range between 0.5 and 5 wt %, based on the total amount of the washing solution of step (3.-2)), is employed as the washing solution, and the solid is washed therewith one or more times, preferably one to three times.

The isolated and optionally washed solid can then be dried, optionally after pulverization, at temperatures of 20-100° C. and at pressures of 0.1 mbar to standard pressure (1013 mbar).

A preferred process for isolating the DMC catalysts employable in accordance with the invention from the suspension by filtration, filtercake washing and drying is described in WO-A 01/80994.

The double metal cyanide (DMC) catalyst is preferably employed in a theoretical amount of 100 to 3000 ppm, preferably of 120 to 2500 ppm, more preferably of 150 to 2200, based on the sum of the masses of the polymeric formaldehyde compound and the alkylene oxide. In the case of a high proportion of the DMC catalyst the heavy metals must be separated before prior to further reaction to afford the polyurethane. No catalytic reaction remains observable below a concentration of 100 ppm of the double metal cyanide (DMC) catalyst.

The process according to the invention employs suspension media with H-functional groups or suspension media without H-functional groups, preferably suspension media without H-functional groups.

In one embodiment, the process according to the invention comprises the steps of:
(α) initial charging of a suspension medium in a reactor
(γ) stepwise or continuous metered addition of the alkylene oxide during the reaction.

In one embodiment of the process according to the invention, the suspension medium in step (a) contains no H-functional groups.

It is preferable when in step (a) a suspension medium containing no H-functional groups is initially charged in the reactor together with DMC catalyst and no polymeric formaldehyde compound is initially charged in the reactor. Alternatively, it is also possible in step (a) to initially charge the reactor with a suspension medium containing no H-functional groups and additionally with a subamount of the polymeric formaldehyde compound and optionally DMC catalyst.

In a preferred embodiment, inert gas, for example argon or nitrogen, an inert gas/carbon dioxide mixture or carbon dioxide is introduced into the resulting mixture of suspension medium and DMC catalyst at a temperature of 40° C. to 120° C., preferably of 50° C. to 100° C. and more preferably of 60° C. to 90° C. and at the same time a reduced pressure (absolute) of 10 mbar to 800 mbar, more preferably of 50 mbar to 200 mbar, is applied.

In an alternative preferred embodiment, the resulting mixture of suspension medium and DMC catalyst is contacted at least once, preferably three times, at a temperature of 40° C. to 120° C., preferably of 50° C. to 100° C. and more preferably of 60° C. to 90° C. with 1.5 bar to 10 bar (absolute), more preferably 3 bar to 6 bar (absolute), of an inert gas (for example argon or nitrogen), an inert gas/carbon dioxide mixture or carbon dioxide and then the gauge pressure is reduced in each case to about 1 bar (absolute).

The DMC catalyst can be added in solid form or as a suspension in a suspension medium or in a mixture of at least two suspension media.

In a further preferred embodiment, in step (a),
(α-I) the suspension medium or a mixture of at least two suspension media is initially charged and
(α-II) the temperature of the suspension medium and/or the H-functional starter substance is brought to 40° C. to 120° C., preferably 50° C. to 100° C. and particularly preferably 60° C. to 90° C. and/or the pressure in the reactor is reduced to less than 500 mbar, preferably 5 mbar to 100 mbar, wherein an inert gas stream (for example of argon or nitrogen), an inert gas/carbon dioxide stream or a carbon dioxide stream is optionally passed through the reactor,
wherein the double metal cyanide catalyst is added to the suspension medium or to the mixture of at least two suspension media in step (α-I) or immediately thereafter in step (α-II) and wherein the suspension medium contains no H-functional groups.

Step (β) serves to activate the DMC catalyst. This step may optionally be performed under an inert gas atmosphere, under an atmosphere of inert gas/carbon dioxide mixture or under a carbon dioxide atmosphere. Activation in the context of the present invention refers to a step in which a subamount of alkylene oxide compound is added to the mixture from step (α) to the DMC catalyst suspension at temperatures of 20° C. to 120° C., preferably of 35° C. to 105° C. and particularly preferably of 50° C. to 90° C. and then the addition of the alkylene oxide compound is stopped, wherein due to a subsequent exothermic chemical reaction an evolution of heat, which can lead to a temperature spike (“hotspot”), is observed and due to the conversion of alkylene oxide and possibly CO₂ a pressure drop in the reactor is observed. The process step of activation is the period from addition of the subamount of alkylene oxide compound, optionally in the presence of CO₂, to the DMC catalyst until evolution of heat occurs. Optionally, the subamount of alkylene oxide compound can be added to the DMC catalyst in a plurality of individual steps, optionally in the presence of CO₂, and the addition of the alkylene oxide compound can in each case then be halted. In this case the process step of activation comprises the period from addition of the first subamount of alkylene oxide compound, optionally in the presence of CO₂, to the DMC catalyst until evolution of heat occurs after addition of the last subamount of alkylene oxide compound. The activation step may generally be preceded by a step for drying the DMC catalyst and optionally the polymeric formaldehyde compound at elevated temperature and/or reduced pressure, optionally with passage of an inert gas through the reaction mixture.

Metered addition of one or more alkylene oxides (and optionally of the carbon dioxide) may in principle be effected in different ways. The metered addition can be commenced from the vacuum or at a previously chosen supply pressure. The supply pressure is preferably established by introduction of an inert gas (for example nitrogen or argon) or of carbon dioxide, wherein the pressure (in absolute terms) is 5 mbar to 100 bar, preferably 10 mbar to 50 bar and by preference 20 mbar to 50 bar.

In a preferred embodiment, the amount of one or more alkylene oxides used in the activation in step (β) is 0.1% to 25.0% by weight, preferably 1.0% to 20.0% by weight, particularly preferably 2.0% to 16.0% by weight (based on the amount of suspension medium used in step (α)). The alkylene oxide may be added in one step or portionwise in two or more subamounts. It is preferable when after addition of a subamount of alkylene oxide compound the addition of the alkylene oxide compound is interrupted until the evolution of heat occurs and the next subamount of alkylene oxide compound is added only then.

In a preferred embodiment of the process according to the invention, step (α) is followed by step (β), wherein in step (β) a subamount of alkylene oxide is added to the mixture from step (α) at a temperature of 20° C. to 120° C., preferably of 35° C. to 105° C. and particularly preferably of 50° C. to 90° C. and wherein the addition of the alkylene oxide compound is then interrupted.

In one embodiment of the process according to the invention, in step (γ) component (X) is metered in continuously or stepwise, preferably continuously. It is preferable when in step (γ) the polymeric formaldehyde compound and the alkylene oxide are metered in continuously or stepwise, preferably continuously.

According to the invention the reaction in step (γ) is carried out at a temperature of 20° C. to 130° C., preferably of 40° C. to 120° C. and particularly preferably of 60° C. to 110° C.

The metered addition of the one or more polymeric formaldehyde compounds, one or more alkylene oxides, one or more components (X) and optionally also of the carbon dioxide can be effected simultaneously or sequentially (in portions); for example, it is possible to add the total amount of carbon dioxide, the amount of polymeric formaldehyde compound and of component (X) and/or the amount of alkylene oxides metered in in step (γ) all at once or continuously. The term “continuously” as used here can be defined as a mode of addition of a reactant such that a concentration of the reactant effective for the copolymerization is maintained, meaning that, for example, the metered addition may be carried out at a constant addition rate, at a varying addition rate or portionwise.

It is possible, during the addition of the alkylene oxide, of component (X) and/or of the polymeric formaldehyde compound, to increase or lower the gas pressure, for example the CO₂ pressure or the inert gas pressure, gradually or stepwise or to leave it constant. The total pressure is preferably kept constant during the reaction by metered addition of, for example, inert gas or carbon dioxide. The metered addition of one or more alkylene oxides, one or more components (X) and/or the one or more polymeric formaldehyde compounds is carried out simultaneously or sequentially with the carbon dioxide metered addition. It is possible to effect metered addition of the alkylene oxide at a constant addition rate or to increase or lower the addition rate gradually or stepwise or to add the alkylene oxide portionwise. The alkylene oxide is preferably added to the reaction mixture at a constant addition rate. If two or more alkylene oxides are used for synthesis of the polyoxymethylene copolymers, the alkylene oxides may be metered in individually or as a mixture. The metered addition of the alkylene oxides/the polymeric formaldehyde compound and/or of component (X) may be effected simultaneously or sequentially via separate metered addition means (feeds) in each case or via one or more metered addition means, wherein the alkylene oxides/the polymeric formaldehyde compounds and/or component (X) may be metered in individually or as a mixture. It is possible via the manner and/or sequence of the metered addition of the polymeric formaldehyde compounds, of the alkylene oxides, of component (X) and/or of the carbon dioxide to synthesize random, alternating, block-type or gradient-type polyoxymethylene-polyoxyalkylene copolymers.

In a preferred embodiment, in step (γ) the metered addition of the one or more polymeric formaldehyde compound(s) and optionally of component (X), preferably of the polymeric formaldehyde compound(s) and component (X), is terminated prior to the addition of the alkylene oxide.

In a further embodiment of the process according to the invention, an excess of carbon dioxide based on the calculated amount of carbon dioxide incorporated in the polyether carbonate polyol is employed, since an excess of carbon dioxide is advantageous because of the inertness of carbon dioxide. The amount of carbon dioxide may be determined via the total pressure under the particular reaction conditions. An advantageous total (absolute) pressure for the copolymerization for preparing the polyethercarbonate polyols has been found to be in the range from 0.01 to 120 bar, preferably 0.1 to 110 bar, particularly preferably from 1 to 100 bar. The carbon dioxide may be supplied continuously or discontinuously. This depends on how quickly the alkylene oxides are consumed and on whether the product is to include any CO₂-free polyether blocks. The amount of the carbon dioxide (reported as pressure) can likewise be varied during addition of the alkylene oxides. CO₂ may also be added to the reactor as a solid and then converted under the selected reaction conditions into the gaseous, dissolved, liquid and/or supercritical state.

A preferred embodiment of the process according to the invention is inter alia characterized in that in step (γ) the total amount of the one or more polymeric formaldehyde compounds is added. This addition may be effected at a constant addition rate, at a varying addition rate or portionwise.

For the process according to the invention it has further been found that the copolymerization in the presence of carbon dioxide (step (γ)) to prepare the polyoxymethylene-polyether carbonate polyol copolymers or the polymerization in the presence of an inert gas such as for example nitrogen to form polyoxymethylene-polyether polyol copolymers is advantageously performed at temperatures of 20° C. to 130° C., preferably of 40° C. to 120° C. and particularly preferably of 60° C. to 110° C. If temperatures are set below 20° C., the reaction generally becomes very slow. At temperatures above 130° C. the amount of undesired by-products increases severely and decomposition of the polymeric formaldehyde compound takes place.

The metered addition of the alkylene oxide, the polymeric formaldehyde compound, component (X) and the DMC catalyst may be effected via separate or combined metered addition points. In a preferred embodiment, the alkylene oxide, component (X) and the polymeric formaldehyde compound are continuously supplied to the reaction mixture via separate metered addition points. This addition of the one or more polymeric formaldehyde compound(s) and/or the one or more component(s) (X) can be effected as a continuous metered addition into the reactor or portionwise.

Steps (α), (β) and (γ) may be performed in the same reactor or may each be performed separately in different reactors. Particularly preferred reactor types are: tubular reactors, stirred tanks, loop reactors.

Polyoxymethylene-polyoxyalkylene copolymers may be prepared in a stirred tank, the stirred tank being cooled via the reactor jacket, internal cooling surfaces and/or cooling surfaces within a pumped circulation circuit, depending on the embodiment and mode of operation. Both in the semi-batch application, where the product is withdrawn only once the reaction has ended, and in the continuous application, where the product is withdrawn continuously, particular attention should be paid to the metered addition rate of the alkylene oxide. Said rate should be adjusted such that despite the inhibiting effect of the carbon dioxide and/or of the polymeric formaldehyde compound the alkylene oxides react sufficiently rapidly. The concentration of free alkylene oxides in the reaction mixture during the activation step (step $) is preferably >0% to 100% by weight, more preferably >0% to 50% by weight, most preferably >0% to 20% by weight (in each case based on the weight of the reaction mixture). The concentration of free alkylene oxides in the reaction mixture during the reaction (step γ) is preferably >0% to 40% by weight, more preferably >0% to 25% by weight, most preferably >0% to 20% by weight, in each case based on the weight of the reaction mixture.

In a preferred embodiment, the activated DMC catalyst/suspension medium mixture that results according to steps (a) and (3) is further reacted with one or more alkylene oxide(s), one or more polymeric formaldehyde compounds, one or more component(s) (X) and optionally carbon dioxide in the same reactor. In a further preferred embodiment, the activated DMC catalyst/suspension medium mixture that results according to steps (a) and ($) is further reacted with alkylene oxides, one or more polymeric formaldehyde compound(s), one or more component(s) (X) and optionally carbon dioxide in a different reaction vessel (for example a stirred tank, tubular reactor or loop reactor).

When conducting the reaction in a tubular reactor the activated catalyst/suspension medium mixture that results according to steps (a) and (3), one or more polymeric formaldehyde compounds, one or more alkylene oxides, one or more component(s) (X) and optionally carbon dioxide are continuously pumped through a tube. The molar ratios of the co-reactants are varied according to the desired polymer. In a preferred embodiment, carbon dioxide is metered in in its liquid or supercritical form to achieve optimal miscibility of the components. It is advantageous to install mixing elements for better mixing of the co-reactants, such as are marketed for example by Ehrfeld Mikrotechnik BTS GmbH, or mixer-heat exchanger elements which simultaneously improve mixing and heat removal.

It is likewise possible to employ loop reactors for preparation of polyoxyethylene-polyoxyalkylene copolymers. These generally include reactors with recycling, for example a jet loop reactor, which can also be operated continuously, or a loop-shaped tubular reactor with suitable apparatuses for circulation of the reaction mixture or a loop of a plurality of serially connected tubular reactors. The use of a loop reactor is advantageous particularly because backmixing may be realized here, so that the concentration of free alkylene oxides in the reaction mixture may be kept within the optimal range, preferably in the range from >0 to 40 wt %, more preferably >0 to 25 wt %, most preferably >0 to 20 wt % (in each case based on the weight of the reaction mixture).

It is preferable when the polyoxymethylene-polyoxyalkylene copolymers are prepared in a continuous process which comprises both a continuous copolymerization and a continuous addition of the one or more polymeric formaldehyde compound(s) and/or one or more component(s) (X).

In a further embodiment of the process according to the invention, in step (γ) the resulting reaction mixture is continuously removed from the reactor.

The invention therefore also provides a process wherein in step (γ) one or more polymeric formaldehyde compounds, one or more alkylene oxide(s), one or more component(s) (X) and DMC catalyst is continuously metered into the reactor optionally in the presence of carbon dioxide and wherein the resulting reaction mixture (containing the reaction product) is continuously removed from the reactor.

For example, for the continuous process for preparing the polyoxymethylene-polyoxyalkylene copolymers according to steps (α) and (β) an activated DMC catalyst/suspension medium mixture is prepared, then, according to step step (γ),
(γ1) a subamount of each of one or more polymeric formaldehyde compound(s), one or more alkylene oxide(s), one or more component(s) (X) and optionally carbon dioxide are metered in to initiate the copolymerization and
(γ2) during the progress of the copolymerization the remaining amount of each of DMC catalyst, one or more polymeric formaldehyde compound(s), alkylene oxides and one or more component(s) (X) is metered in continuously optionally in the presence of carbon dioxide, with simultaneous continuous removal of resulting reaction mixture from the reactor.

In step (γ), the DMC catalyst is preferably added in the form of a suspension in the suspension medium with H-functional groups or suspension medium without H-functional groups, preferably suspension medium without H-functional groups, the amount preferably being chosen such that the content of DMC catalyst in the resulting reaction product is 10 to 10 000 ppm, more preferably 20 to 5000 ppm, and most preferably 50 to 3000 ppm.

Preferably, steps (α) and (β) are performed in a first reactor, and the resulting reaction mixture is then transferred into a second reactor for the copolymerization of step (γ). However, it is also possible to perform steps (α), (β) and (γ) in one reactor.

It has also been found that the process of the present invention can be used for preparation of large amounts of the polyoxymethylene-polyoxyalkylene copolymer product, wherein a DMC catalyst activated according to steps (α) and (β) in a suspension medium is initially used, and the DMC catalyst is added without prior activation during the copolymerization (γ).

A particularly advantageous feature of the preferred embodiment of the present invention is thus the ability to use “fresh” DMC catalysts without activation for the subamount of DMC catalyst which is added continuously in step (γ). An activation of DMC catalysts to be performed analogously to step (β) entails not just additional attention from the operator, thus resulting in an increase in manufacturing costs, but also requires a pressure reaction vessel, thus also resulting in an increase in the capital costs in the construction of a corresponding production plant. Here, “fresh” catalyst is defined as unactivated DMC catalyst in solid form or in the form of a slurry in a polymeric formaldehyde compound or suspension medium. The ability of the present process to use fresh unactivated DMC catalyst in step (γ) enables significant savings in the commercial preparation of polyoxymethylene-polyalkylene oxide copolymers and is a preferred embodiment of the present invention.

The term “continuously” used here can be defined as the mode of addition of a relevant catalyst or reactant such that an essentially continuous effective concentration of the DMC catalyst or the reactant is maintained. Catalyst feeding may be effected in a truly continuous manner or in relatively tightly spaced increments. Equally, continuous addition of the polymeric formaldehyde and/or of component (X) may be effected in a truly continuous manner or in increments. There would be no departure from the present process in adding a DMC catalyst or reactants incrementally such that the concentration of the materials added drops essentially to zero for a period prior to the next incremental addition. However, it is preferable for the DMC catalyst concentration to be kept substantially at the same concentration during the main portion of the course of the continuous reaction, and for starter substance to be present during the main portion of the copolymerization process. Incremental addition of DMC catalyst and/or reactant that does not significantly affect the characteristics of the product is nevertheless “continuous” in the sense in which the term is used here. It is possible, for example, to provide a recycling loop in which a portion of the reacting mixture is recycled to a prior point in the process, thus smoothing out discontinuities caused by incremental additions.

In an optional step (δ) the reaction mixture continuously removed in step (γ) which generally has an alkylene oxide content of from 0.05% by weight to 10% by weight may be transferred into a postreactor in which, by way of a postreaction, the content of free alkylene oxide is reduced to less than 0.05% by weight in the reaction mixture. The postreactor employed may be a tubular reactor, a loop reactor or a stirred tank for example.

The pressure in this postreactor is preferably at the same pressure as in the reaction apparatus in which reaction step (γ) is performed. The pressure in the downstream reactor can, however, also be selected at a higher or lower level. In a further preferred embodiment, the carbon dioxide, after reaction step (γ), is fully or partly released and the downstream reactor is operated at standard pressure or a slightly elevated pressure. The temperature in the downstream reactor is preferably 50° C. to 150° C. and particularly preferably 80° C. to 140° C.

The present invention further provides polyoxymethylene-polyoxyalkylene copolymers obtainable by the process according to the invention.

In one embodiment of the invention, the polyoxymethylene-polyalkylene oxide copolymer has an oxymethylene group content of 1% by weight to 70% by weight, preferably of 10% by weight to 50% by weight and particularly preferably of 20% by weight to 50% by weight based on the polyoxymethylene-polyalkylene oxide copolymer product and determined by the 1H-NMR method described in the experimental section.

In one embodiment, the polyoxymethylene copolymers have a number-average molecular weight of ≤15 000 g/mol, preferably ≤9500 g/mol, particularly preferably ≤6000 g/mol, very particularly preferably ≤5000 g/mol, especially of 200 g/mol to 9500 g/mol, preferably of 500 g/mol to 5000 g/mol. The number-average molecular weight may be determined for example by gel permeation chromatography (GPC) against polystyrene standards for example and/or via experimentally determined hydroxyl numbers (OH #).

In a further embodiment, the polyoxymethylene copolymers have a number-average molecular weight of 500 g/mol to 5000 g/mol, preferably of 1000 g/mol to 4000 g/mol and particularly preferably of 1500 g/mol to 3500 g/mol. The number-average molecular weight may be determined for example by gel permeation chromatography (GPC) against polystyrene standards for example and/or via experimentally determined hydroxyl numbers (OH #).

The polyoxymethylene copolymers according to the invention preferably have terminal hydroxyl groups and preferably have a hydroxyl functionality F≥2 (number of hydroxyl groups per molecule).

In a further embodiment of the polyoxymethylene copolymers, said polymers have a monomodal molecular weight distribution and a polydispersity index (PDI) of ≤2.5, preferably ≤2.2.

The polyoxymethylene copolymers obtainable by the process according to the invention preferably contain less than 1.0% by weight, especially less than 0.5% by weight, based on the total mass of the obtained polyoxymethylene copolymer, formate and/or methoxy impurities. The polyoxymethylene copolymers obtainable by the process according to the invention generally have a low content of by-products and decomposition products, such as formate, methoxy traces, monomeric and oligomeric formaldehyde and residual monomers, and may be readily processed, especially by reaction with di-tri- and/or polyisocyanates to afford polyurethanes, isocyanate-functionalized polyurethane prepolymers or polyisocyanurates, especially polyurethane thermoplastics, polyurethane coatings, fibers, elastomers or adhesives, and especially also polyurethane foams including flexible foams (for example flexible slabstock polyurethane foams and flexible molded polyurethane foams) and rigid foams. Polyurethane applications preferably employ polyoxymethylene copolymers having a functionality of at least 2. In addition, the polyoxymethylene copolymers obtainable by the process according to the invention may be used in applications such as washing and cleaning composition formulations, adhesives, paints, coatings, functional fluids, drilling fluids, fuel additives, ionic and nonionic surfactants, lubricants, process chemicals for papermaking or textile manufacture, or cosmetic/medicinal formulations. The person skilled in the art is aware that, depending on the respective field of use, the polymers to be used have to fulfill certain physical properties, for example molecular weight, viscosity, polydispersity, functionality and/or hydroxyl number (number of terminal hydroxyl groups per molecule).

The invention further relates to a process for preparing a polyurethane polymer comprising the step of reacting a polyisocyanate component with a polyol component, wherein the polyol component comprises the polyoxymethylene-polyoxyalkylene copolymer according to the invention.

In one embodiment of this process, the polyurethane polymers are flexible polyurethane foams or rigid polyurethane foams. In a further embodiment of this process, the polyurethane polymers are thermoplastic polyurethane polymers.

The invention therefore likewise provides a polyurethane polymer obtainable by reaction of a di-, tri- and/or polyisocyanate with at least one polyoxymethylene copolymer according to the invention.

The invention likewise provides a flexible polyurethane foam or a rigid polyurethane foam obtainable by reaction of a di-, tri- and/or polyisocyanate with at least one polyoxymethylene copolymer according to the invention.

The invention also includes the use of polyoxymethylene copolymers according to the present invention for production of polyurethanes, washing and cleaning composition formulations, drilling fluids, fuel additives, ionic and nonionic surfactants, lubricants, process chemicals for papermaking or textile production, or cosmetic formulations.

### EXAMPLES

### Employed Compounds:

Paraformaldehyd (pFA)
pFA-1 paraformaldehyd, formaldehyde content 94.5-96.5%, Granuform M®, Prefere Paraform GmbH & Co. KG
pFA-2 was synthesized as in example 2 of European patent application application number EP18207740 filed on Nov. 22, 2018.

Alkylene Oxide
PO purity 99%, Sigma-Aldrich
Component (X)
X-1 trifunctional polyether polyol having a hydroxyl number of 421 mg(KOH)/g, Arcol® Polyol 1030 from Covestro AG
X-2 Sorbitol, 99% purity, Sigma-Aldrich

### Double Metal Cyanide (DMC) Catalyst

The DMC catalyst used in all examples was DMC catalyst prepared according to example 6 in WO 01/80994 A1, containing zinc hexacyanocobaltate, tert-butanol and polypropylene glycol having a number-average molecular weight of 1000 g/mol.

Suspension Medium
cPC purity 99%, Sigma-Aldrich

### DESCRIPTION OF THE METHOD

### Gel Permeation Chromatography (GPC):

The weight-average and number-average molecular weights Mw and Mn of the resulting polymers were determined by gel permeation chromatography (GPC). The GPC measurements were made at 40° C. in tetrahydrofuran (THF, flow rate: 1.0 mL/min) on the basis of DIN 55672-1. The column set consisted of five columns: PSS, 5 μL, 8×50 mL precolumn, 2 PSS SVD, 5 μL, 100 Å, 8×300 mm, 2 PSS SVD, 5 μL, 1000 Å, 8×300 mm)). Samples (concentration 2-3 g L-1, injection volume 100 RL) were injected with an Agilent technologies 1100 apparatus. An Agilent 1200 series RID detector was used. The raw data were processed with a PSS WinGPC Unity software package. Polystyrene kits of known molecular weight were used as calibration standards (PSS ReadyCal kit in a range from 266 Da to 66 000 Da was used). The number-average molecular weight thus determined was reported as Mₐ in the examples.

### Proton Resonance Spectroscopy (¹H NMR)

The proportion of incorporated formaldehyde (FA) in the resulting polymer (FA content) was determined by ¹H-NMR spectroscopy (Bruker, AV III HD 600, 600 MHz; pulse program zg30, 16 scans). Each sample was dissolved in deuterated chloroform. The relevant resonances in the ¹H-NMR spectrum (based on TMS=0 ppm) are as follows:
1.06-1.24 ppm (m): methyl group of the polymer backbone (—OCH2CHCH3-)
1.49 ppm (d): methyl group (CH3-) of propylene carbonate (cPC)
3.30-3.98 ppm (m): remaining PPG backbone signals (—OCH2CHCH3-)
4.04 ppm (dd): CH2 group of propylene carbonate (cPC)
4.58 ppm (dd): CH2 group of propylene carbonate (cPC)
4.68-4.94 ppm (m): overlap of signals from FA group of polymer backbone (—CH2O—) and CH group of propylene carbonate (cPC)
4.88 ppm (qdd): CH group of propylene carbonate (cPC)

After standard processing of the spectra (phase and baseline correction), the signals were integrated (area: f(n)) and the mass fraction of the FA incorporated in the polymer is calculated as follows (calculation of the weight fractions employed the following molar masses (g/mol): PO in PPO=58, FA=30):

$$Mass - weighted proportion of PPG in g / mol : MA ( PPG ) = \frac{F ( a )}{3} \times 58 g / mol$$

$$Mass - weighted proportion of FA in g / mol : MA ( FA ) = \frac{F ( f ) - F ( b ) / 3}{2} \times 30 g / mol$$

$$FA content in \% by weight : ω = \frac{MA ( FA )}{MA ( PPG ) + MA ( FA )} \times 100$$

### Example 1: Single-Step Preparation of the Polyoxymethylene-Polyalkylene Oxide Copolymer Having a Functionality of F=2.8 and a Target Molar Mass Mn of 2825 g/Mol

51 g of pFA-2, 49.1 g of X-1 as component (X) and 800 mg DMC catalyst were suspended in 400 g of cPC in a 1.0 L pressure reactor. Inertization (N₂) was performed for 30 min at 70° C. with stirring (500 rpm). After achieving the temperature 125 g of propylene oxide (21.6% by weight) were added to the suspension at a feed rate of 10 g/min with stirring (1000 rpm). Onset of the reaction was indicated by a temperature spike (“hotspot”) in conjunction with a simultaneous pressure drop. This was followed by metered addition of 175 g of PO at a continuous addition rate of 1 g/min. Once addition was complete the mixture was subjected to further stirring at 70° C. until the exothermic reaction had abated and until a constant pressure was achieved. The product mixture was then withdrawn and degassed at 60° C. and 10 mbar using a rotary evaporator. The reaction mixture was analyzed using GPC and NMR analysis.

A formaldehyde content in the polymer of 13.4% by weight was determined by NMR.

### Example 2: Single-Step Preparation of the Polyoxymethylene-Polyalkylene Oxide Copolymer Having a Functionality of F=2.8 and a Target Molar Mass Mn of 2825 g/Mol

The experiment was performed analogously to example 1, wherein the amount of X-1 as component X was not initially charged in the reactor but rather metered in simultaneously with the continuous PO metered addition over the first 100 g of PO. The remaining 75 g PO were accordingly metered in without the co-starter. A formaldehyde content in the polymer of 11.1% by weight was determined by NMR.

### Example 3: Single-Step Preparation of the Polyoxymethylene-Polyalkylene Oxide Copolymer Having a Functionality of F=2.8 and a Target Molar Mass Mn of 2823 g/Mol

10 g of pFA-1 and 387 mg of DMC catalyst were suspended in 150 g of cPC in a 1.0 L pressure reactor. Inertization was performed (25 L(N₂)/h at 30 mbar) for 30 min at 60° C. and with stirring (500 rpm). The reaction mixture was then heated to 70° C. with stirring (1000 rpm). After achieving the temperature 40 g of propylene oxide (11% by weight) were added quickly at a feed rate of 10 g/min. Onset of the reaction was indicated by a temperature spike (“hotspot”) in conjunction with a simultaneous pressure drop. This was followed at 100° C. and a stirrer speed of 1000 rpm with a metered addition of 281 g of PO at a continuous addition rate of 0.9 g/min and 51 g of pFA-1 and 4.99 g of X-2 as component (X) as a suspension in 273 g of cPC at a continuous addition rate of 1.7 g/min. Once addition was complete the mixture was subjected to further stirring at 70° C. until the exothermic reaction had abated and until a constant pressure was achieved (about 35 min). The product mixture was then withdrawn and degassed at 60° C. and 10 mbar using a rotary evaporator. The reaction mixture was analyzed using GPC and NMR analysis.

A formaldehyde content in the polymer of 24.9% by weight was determined by NMR.

Comparative example 4: Two-step preparation of a polyol mixture (“blend”) having a functionality of F=2.8 and a target molar mass Mn of 2825 g/mol by two-sep mixing of a polyoxymethylene-polyalkylene oxide copolymer having a functionality of 2 and a target molar mass of 2825 g/mol without addition of component (X) with a trifunctional polyol having a molar mass of 2825 g/mol.

For the preparation of the polyoxymethylene-polyalkylene oxide copolymer having a functionality of 2 and a target molar mass of 2825 g/mol without addition of component (X), 51 g of pFA-2 and 800 mg of dried DMC catalyst were suspended in 400 g of cPC in a 1.0 L pressure reactor. Inertization (N2) was performed for 30 min at 70° C. with stirring (500 rpm). 21 g of propylene oxide were quickly added to the suspension at a feed rate of 10 g/min. Onset of the reaction was not observed and preparation of the polyoxymethylene-polyalkylene oxide copolymer and thus also of the polyol mixture was therefore not possible.

TABLE 1

| | | | | | Continuous | | | | |
|---|---|---|---|---|---|---|---|---|---|
| | pFA/M(pFA) | Component | Mₙ(target) | n(X) ^{d)} | addition | m(DMC)^{a)} | Mₙ(GPC) | | pFA |
| Ex. | [g/mol] | (X) | [g/mol] | [mol %] | in step γ | [ppm] | [g/mol]^{b)} | PDI | [% by wt.] |
| 1 | pFA-2 2000 | X-1 | 2825 | 82 | PO | 2000 | 3096 | 1.08 | 13.4 |
| 2 | pFA-2 2000 | X-1 | 2825 | 82 | PO + X-1 | 2000 | 3133 | 1.23 | 11.1 |
| 3 | pFA-1 480 | X-2 | 2823 | 18 | PO + X-2 + | 1000 | 3557 | 1.278 | 15.6 |
| | | | | | pFA-1 | | | | |
| 4 (comp.) | pFA-2 2000 | — | 2825 | — | PO | 2000 | no | — | |
| | | | | | | | polymer^{c)} | | |

^{a)}DMC catalyst loading m(DMC) based on the sum of the masses of the polymeric formaldehyde compound and the alkylene oxide,
^{b)}number-average molecular weight of the polyoxymethylene-polyoxyalkylene copolymer,
^{c)}no chain-extended product was obtained,
^{d)} mole fraction of component (X) n(X) based on the sum of the mole fraction of the polymeric formaldehyde compound n(pFA) and the mole fraction of component (X)

1. A process for preparing a polyoxymethylene-polyoxyalkylene copolymer, the process comprising:
reacting a polymeric formaldehyde compound of an alkylene oxide and a component (X) in the presence of a double metal cyanide (DMC) catalyst;
wherein the polymeric formaldehyde compound has at least one terminal hydroxyl group;
wherein the component (X) comprises at least one terminal hydroxyl group, at least one terminal carboxyl group and/or at least one terminal thiol group;
wherein the theoretical molar mass of the polymeric formaldehyde compound is greater than the theoretical molar mass of the component (X);
wherein the component (X) is distinct from compounds of formula (I), 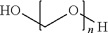
and wherein n in formula (I) is a natural number from 0 to 100.

2. The process as claimed in claim 1, wherein the component (X) comprises one to six terminal hydroxyl groups, one to six terminal carboxyl groups and/or one to six terminal thiol groups.

3. The process as claimed in claim 1, wherein the component (X) is one or more compounds selected from the group consisting of ethylene glycol, diethylene glycol, polyethylene glycol, methylpropylene glycol, dipropylene glycol, polypropylene glycol, butane-1,3-diol, butane-1,4-diol, 1,1,1-trimethylolpropane, glycerol, pentaerythritol, sorbitol, sucrose, xylitol, propane-1,2-diol, and propane-1,3-diol.

4. The process as claimed in claim 1, wherein the mole fraction of the component (X) is from 0.5 mol % to 95 mol % based on the sum of the molar amounts of the polymeric formaldehyde compound and the component (X).

5. The process as claimed in claim 1 further comprises the steps of:
(α) initial charging of a suspension medium in a reactor; and
(γ) stepwise or continuous metered addition of the alkylene oxide during the reaction.

6. The process as claimed in claim 5, wherein in step (γ) the component (X) is metered in continuously or stepwise.

7. The process as claimed in claim 5, wherein in step (γ) the polymeric formaldehyde compound and the alkylene oxide are metered in continuously or stepwise.

8. The process as claimed in claim 5, wherein step (γ) is carried out at a temperature of 20° C. to 130° C.

9. The process as claimed in claim 5, wherein in step (α) the suspension medium contains no H-functional groups.

10. The process as claimed in claim 9, wherein in step (α) the suspension medium containing no H-functional groups is initially charged in the reactor together with DMC catalyst.

11. The process as claimed in claim 10, wherein the process further comprises:
(β) a subamount of alkylene oxide is added to the mixture from step (α) at a temperature of 20° C. to 120° C., wherein the addition of the alkylene oxide compound is then interrupted.

12. The process as claimed in claim 1, wherein the alkylene oxide is one or more compounds selected from the group consisting of ethylene oxide, propylene oxide, styrene oxide and cyclohexene oxide.

13. A polyoxymethylene-polyoxyalkylene copolymer produced by the process as claimed in claim 1.

14. The polyoxymethylene-polyalkylene oxide copolymer as claimed in claim 13, wherein the polyoxymethylene-polyalkylene oxide copolymer comprises an oxymethylene group content of 1% by weight to 70% by weight based on the polyoxymethylene-polyalkylene oxide copolymer product.

15. A process for preparing a polyurethane polymer comprising reacting a polyisocyanate component with a polyol component, wherein the polyol component comprises the polyoxymethylene-polyoxyalkylene copolymer as claimed in claim 13.

16. The process as claimed in claim 1, wherein the component (X) comprises at least one terminal hydroxyl group.

17. The process as claimed in claim 2, wherein the component (X) comprises at least one of
three to six terminal hydroxyl groups,
three to six terminal carboxyl groups and
three to six terminal thiol groups.

18. The process as claimed in claim 3, wherein the component (X) is one or more compounds selected from the group consisting of polypropylene glycol, 1,1,1-trimethylolpropane, glycerol and sorbitol.

19. The process as claimed in claim 4, wherein the mole fraction of component (X) is from 10 mol % to 85 mol % based on the sum of the molar amounts of the polymeric formaldehyde compound and the component (X).

20. The process as claimed in claim 6, wherein in step (γ) component (X) is metered in continuously.
